(19) United States
(12) Patent Application Publication
(10) Pub. No.: US 2007/0168186 A1
(43) Pub. Date: Jul. 19, 2007

(54) Audio coding apparatus, audio decoding apparatus, audio coding method and audio decoding method

(75) Inventor: Hiroyasu Ide, Fussa-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/653,506

(22) Filed: Jan. 16, 2007

(30) Foreign Application Priority Data
Jan. 18, 2006 (JP) 2006-010319

(51) Int. Cl. G10L 19/14

(52) U.S. Cl. 704/205

(57) ABSTRACT

An audio coding apparatus comprises a frequency converter which performs frequency conversion on an audio signal to obtain frequency conversion coefficients, an importance calculator which calculates importance levels of frequency components corresponding to the frequency conversion coefficients obtained by the frequency converter, a coder which performs entropy coding of the frequency conversion coefficients to generate codes of the frequency conversion coefficients, and a comparing unit which compares an amount of the codes generated by the coder with a preset target code amount, wherein the coder performs the entropy coding in order of the importance levels until the comparing unit determines that the amount of the codes generated by the coder reaches the target code amount.

### CROSS-REFERENCE TO RELATED APPLICATIONS

This application is based upon and claims the benefit of priority from prior Japanese Patent Application No. 2006-010319, filed Jan. 18, 2006, the entire contents of which are incorporated herein by reference.

### BACKGROUND OF THE INVENTION

1. Field of the Invention

The present invention relates to an audio coding apparatus, an audio decoding apparatus, an audio coding method and an audio decoding method.

2. Description of the Related Art

A conventional audio coding method processes an audio signal by frequency conversion and entropy coding. The amount of the generated codes is controlled below a target value. In Jpn. Pat. Appln. KOKAI Publication No. 2005-128404, the following entropy coding method is disclosed. That is, frequency conversion coefficients are repeatedly entropy-coded while reducing the frequency conversion coefficients to be coded until the amount of the generated codes reaches the target value.

However, in the above conventional audio coding method, it is necessary to repeatedly perform the same entropy coding many times until the amount of the generated codes reaches the target value. Therefore, there occurs a problem that the calculation amount (processing load) increases.

### BRIEF SUMMARY OF THE INVENTION

According to an embodiment of the present invention, an audio coding apparatus comprises:

a frequency converter which performs frequency conversion on an audio signal to obtain frequency conversion coefficients;

an importance calculator which calculates importance levels of frequency components corresponding to the frequency conversion coefficients obtained by the frequency converter;

a coder which performs entropy coding of the frequency conversion coefficients to generate codes of the frequency conversion coefficients; and

a first comparing unit which compares an amount of the codes generated by the coder with a preset target code amount, wherein

the coder performs the entropy coding in order of the importance levels until the first comparing unit determines that the amount of the codes generated by the coder reaches the target code amount.

According to another embodiment of the present invention, an audio coding method comprises:

performing frequency conversion on an audio signal to obtain frequency conversion coefficients;

calculating importance levels of frequency components corresponding to the frequency conversion coefficients obtained by the frequency conversion;

performing entropy coding of the frequency conversion coefficients to generate codes of the frequency conversion coefficients; and

comparing an amount of the codes generated by the entropy coding with a preset target code amount, wherein

the entropy coding is performed in order of the importance levels until it is determined that the amount of the codes generated by the entropy coding reaches the target code amount.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention in which:

FIG. 1 is a schematic block diagram showing the electric configuration of an audio coding apparatus 100;

FIG. 2 is a schematic block diagram showing the electric configuration of an audio decoding apparatus 200;

FIG. 3 is a diagram showing an example of band division in a frequency domain;

FIG. 4 is a flowchart of audio coding processing performed by the audio coding apparatus 100;

FIG. 5 is a flowchart of entropy coding processing performed by the audio coding apparatus 100;

FIG. 6 is a table showing the relation between frequency conversion coefficients and energy for each frequency component;

FIG. 7 is a flowchart of audio decoding processing performed by the audio decoding apparatus 200;

FIG. 8 is a flowchart of encoding processing according to a first modification;

FIG. 9 is a table showing the relation among the frequency conversion coefficients, the energy, and a flag for each frequency component; and

FIG. 10 is a flowchart of encoding processing according to a second modification.

### DETAILED DESCRIPTION OF THE INVENTION

An embodiment of an audio coding apparatus according to the present invention will now be described with reference to the accompanying drawings.

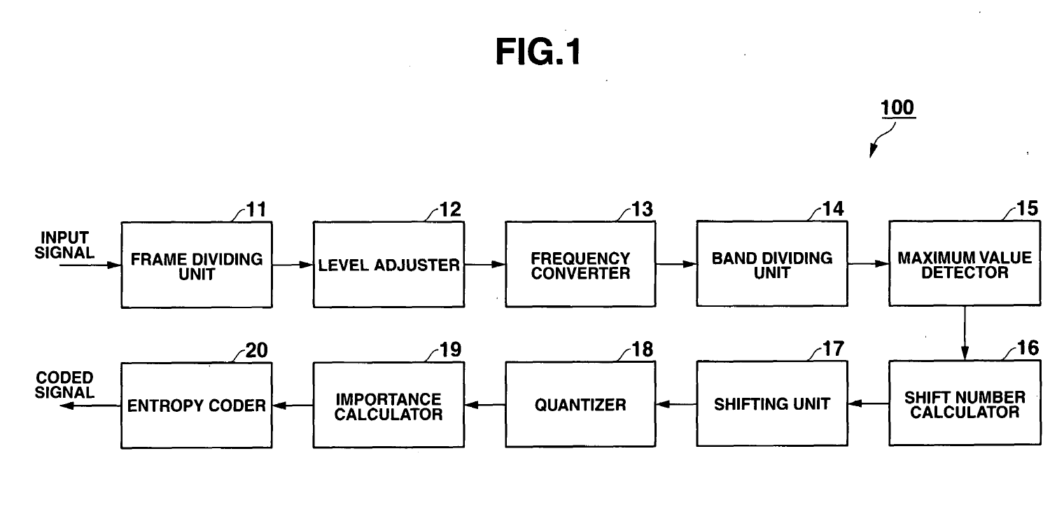

FIG. 1 is a schematic block diagram showing the electric configuration of an audio coding apparatus 100. The audio coding apparatus 100 includes a frame dividing unit 11, a level adjuster 12, a frequency converter 13, a band dividing unit 14, a maximum value detector 15, a shift number calculator 16, a shifting unit 17, a quantizer 18, an importance calculator 19, and an entropy coder 20. An input signal of the audio coding apparatus 100 is assumed to be a digital audio signal which is 16-bit quantized by 16 kHz sampling, for example.

The frame dividing unit 11 divides the input audio signal into frames having constant length. A frame is a unit of coding (compression). A frame of signal is output to the level adjuster 12. One frame contains m (m≧1) blocks. A block is a unit of the modified discrete cosine transforms (MDCT). The block length corresponds to the order of MDCT. An ideal tap length of MDCT is 512 taps in the present embodiment.

The level adjuster 12 adjusts the level (amplitude) of the input audio signal included in a frame. The level-adjusted signal is output to the frequency converter 13. The level adjustment is performed to suppress the maximum amplitude in one frame of the input signal to be equal to or less than the predetermined number of bits (hereinafter referred to as a suppression target). In the audio signal, the maximum amplitude of the audio signal is suppressed to be 10 bits or less, for example. When the maximum amplitude in one frame of the input signal is expressed by n bits and the suppression target is expressed by N bits, the entire signal in the frame is shifted towards the least significant bit (LSB) side by the number of bits specified by a first shift bit number. The first shift bit number is defined by the absolute value of the “shift bit” expressed in formula (1).

$$shift\_bit = \{ \begin{matrix}0 & ( n \leq N ) \\ N - n & ( n > N )\end{matrix} \qquad ( 1 )$$

When decoding, it is necessary to restore the suppressed signal to the original signal. Therefore, a signal expressing the “shift_bit” is required to be output as a part of the coded signal.

The frequency converter 13 performs frequency conversion on the input audio signal. The frequency conversion coefficients converted by the frequency converter 13 are output to the band dividing unit 14. The MDCT is used for the frequency conversion on the audio signal in the present embodiment. A sequence of the input audio signal contained in one frame is denoted by {xₙ|n=0, . . . , M−1}. The length of the MDCT block is expressed by M. The MDCT coefficients (frequency conversion coefficients) {Xₖ|k=0, . . . , M/2−1} are defined according to formula (2).

$${X}_{k} = {\sum }_{n = 0}^{M - 1} {x}_{n} \cdot {h}_{n} \cdot cos \{ \frac{2 π}{M} ( \frac{k + 1}{2} ) ( n + \frac{M}{4} + \frac{1}{2} ) \} \qquad ( 2 )$$

where hₙ is a window function and defined by formula (3).

$${h}_{n} = sin \{ \frac{π}{M} ( n + \frac{1}{2} ) \} \qquad ( 3 )$$

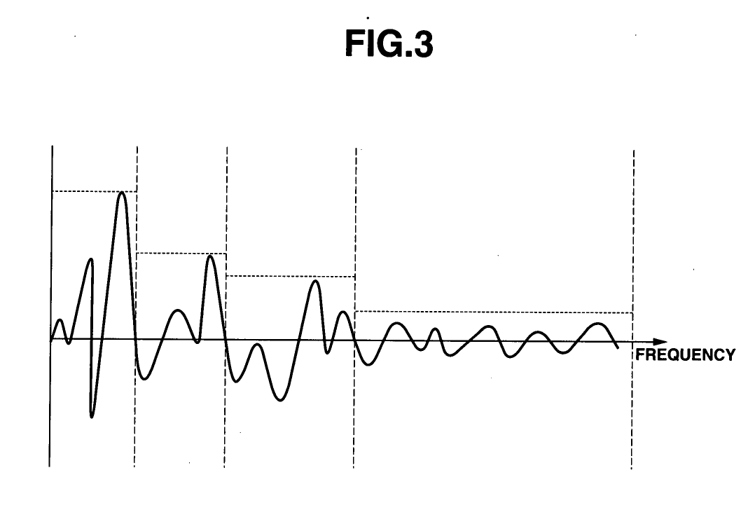

The band dividing unit 14 divides the frequency domain of the frequency conversion coefficients into bands according to the characteristic of human hearing. As shown in FIG. 3, the band dividing unit 14 divides the frequency domain so that a lower frequency band becomes narrower and a higher frequency band becomes wider. For example, when the sampling frequency of the audio signal is 16 kHz, the division boundaries are set to 187.5 Hz, 437.5 Hz, 687.5 Hz, 937.5 Hz, 1312.5 Hz, 1687.5 Hz, 2312.5 Hz, 3250 Hz, 4625 Hz and 6500 Hz. The frequency domain is divided into eleven bands.

The maximum value detector 15 detects the maximum absolute values of the frequency conversion coefficients in the respective bands.

The shift number calculator 16 calculates the number of bits which is referred to as a second shift bit number hereinafter. The shifting unit 17 shifts the frequency conversion coefficients contained in a band by the number of bits specified by the second shift bit number. The calculation of the second shift bit number is performed in such a manner that the maximum values in the respective bands are suppressed to be equal to or smaller than quantization bit rates. The quantization bit rates are preset for the respective bands. For example, in the case where the maximum absolute value of the frequency conversion coefficients in a band is expressed by “1101010” (binary number), the maximum value in the band is expressed by eight bits including a sign bit. Therefore, when the quantization bit rate is preset to 6 bits in the band, the calculation result of the second shift bit number in the band is two. It is preferable to preset the quantization bit rates in such a manner that the larger number of bits is set for the lower frequency band and the smaller number of bits is set for the higher frequency band, based on the characteristic of the human hearing. For example, five bits through eight bits are allocated to the higher frequency band through the lower frequency band.

The shifting unit 17 shifts the entire frequency conversion coefficients data in the respective bands to the LSB side by the numbers of bits specified by the second shift bit numbers. The frequency conversion coefficients data subjected to the shift operation is output to the quantizer 18. When decoding, it is necessary to restore the shifted frequency conversion coefficient data to the original data. Therefore, a signal expressing the second shift bit number is output as a part of the coded signal for each band.

The quantizer 18 quantizes the frequency conversion coefficients signal input from the shifting unit 17 in a prescribed manner (for example, scalar quantization). The quantized frequency conversion coefficients signal is output to the importance calculator 19.

The importance calculator 19 calculates importance levels of the frequency conversion coefficients signal for respective frequency components. The calculated importance levels are used for range coding by the entropy coder 20. The amount of codes corresponding to a predetermined target code amount is created by coding in accordance with the calculated importance level. The importance level which is corresponding to a frequency component is represented by total energy of the frequency conversion coefficients which are corresponding to the frequency component. In the case where m blocks are contained in one frame, the MDCT operations are executed on the respective m blocks. Accordingly, m frequency conversion coefficients are derived from the m blocks for each frequency component. An i-th frequency conversion coefficient calculated from a j-th MDCT block is expressed by fᵢⱼ. Further, i-th (i=0, . . . , M/2−1) frequency conversion coefficients calculated from the respective MDCT blocks are collectively denoted by {fᵢⱼ|j=0, . . . , m−1}. Hereinafter, the index i is referred to as a frequency index. Energy gᵢ corresponding to the frequency component specified by the frequency index i is defined according to formula (4).

$$gi = {\sum }_{j = 0}^{m - 1} {f}_{ij}^{2} \qquad ( 4 )$$

The frequency component having larger value of energy gᵢ corresponds to the higher importance level. FIG. 6 shows the relation between the frequency conversion coefficients {fᵢⱼ|j=0, . . . , m−1} and energy gᵢ which are specified by the respective frequency indexes i. For every frequency component, energy gᵢ is calculated from m frequency conversion coefficients. In addition, the value of the energy gᵢ may be multiplied by a weight coefficient depending on the frequency. For example, the energy gᵢ of a frequency lower than 500 Hz is multiplied by 1.3, the energy gᵢ of a frequency not lower than 500 Hz and lower than 3500 Hz is multiplied by 1.1, and the energy gᵢ of a frequency not lower than 3500 Hz is multiplied by 1.0, according to the characteristic of human hearing.

The entropy coder 20 executes entropy coding on the frequency index i and corresponding m frequency conversion coefficients in order of the importance levels calculated by the importance calculator 19. A sequence of the codes generated in order of the importance levels is output as coded data (compressed signal) until the amount of the generated codes reaches the predetermined target code amount.

The entropy coding is a coding method which codes the signal in order to reduce the code length of the entire signal according to statistical nature of the signal. That is, a short code is assigned to data which frequently appears and a long code is assigned to data which appears less frequently. A Huffman coding, an arithmetic coding, a range coding and the like are the examples of the entropy coding. In the present embodiment, the range coding is used as the entropy coding.

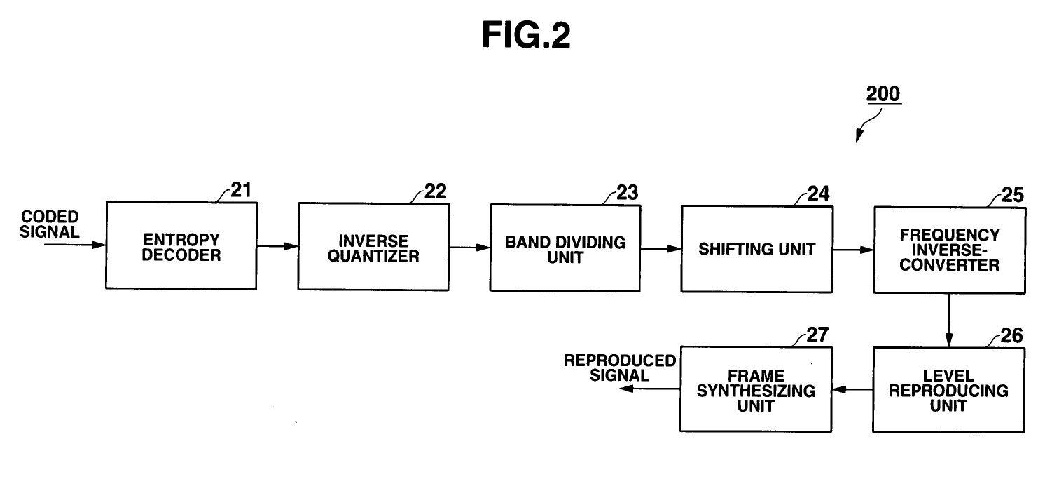

FIG. 2 shows the electric configuration of an audio decoding apparatus 200 according to the present embodiment. The audio decoding apparatus 200 decodes the signal coded by the audio coding apparatus 100. As shown in FIG. 2, the audio decoding apparatus 200 includes an entropy decoder 21, an inverse quantizer 22, a band dividing unit 23, a shifting unit 24, a frequency inverse-converter 25, a level reproducing unit 26, and a frame synthesizing unit 27.

The entropy decoder 21 decodes an input signal subjected to the entropy coding. The decoded input signal is output to the inverse quantizer 22 as a frequency conversion coefficients signal.

The inverse quantizer 22 performs inverse quantization (for example, inverse scalar quantization) on the frequency conversion coefficients decoded by the entropy decoder 21. In the case where the number of the frequency conversion coefficients contained in a processing target frame are smaller than the number of the coefficients calculated at the time of the frequency conversion, the inverse quantizer 22 substitutes a preset value (for example, zero) for the frequency conversion coefficients corresponding to the deficient frequency components. The substitution is performed in such a manner that the values of the energy corresponding to the deficient frequency components are maintained smaller than the values of the energy corresponding to the input frequency components. The inverse quantizer 22 outputs the frequency conversion coefficients ranging over the entire frequency domain into the band dividing unit 23.

The band dividing unit 23 divides the frequency domain of the data obtained by the inverse quantization into bands according to the characteristic of human hearing. The band division is performed in such a manner that a lower frequency band becomes narrower and a higher frequency band becomes wider, in the same way as in the band division by the band dividing unit 14 in the audio coding apparatus 100.

The shifting unit 24 shifts the data of the frequency conversion coefficients acquired by the inverse quantization in the inverse quantizer 22 for the respective divided bands. The data is shifted toward an opposite direction to shifting by the shifting unit 17 in the audio coding apparatus 100. The number of bits to be shifted coincides with the number of bits shifted by the shifting unit 17 when coding, i.e., the second shifted bit number. The data of the frequency conversion coefficients subjected to shifting is output to the frequency inverse-converter 25.

The frequency inverse-converter 25 performs the inverse frequency conversion (for example, inverse MDCT) on the frequency conversion coefficients data subjected to shifting by the shifting unit 24. Thus, an audio signal is converted from the frequency domain to the time domain. The audio signal subjected to the inverse frequency conversion is output to the level reproducing unit 26.

The level reproducing unit 26 restores the level (amplitude) of the audio signal input from the frequency inverse-converter 25. The level of the signal controlled by the level adjuster 12 in the audio coding apparatus 100 is restored to the original level by level reproducing. The audio signal subjected to level reproducing is output to the frame synthesizing unit 27.

The frame synthesizing unit 27 combines the frames which are the units of coding and decoding. The frame-combined signal is output as a reproduction signal.

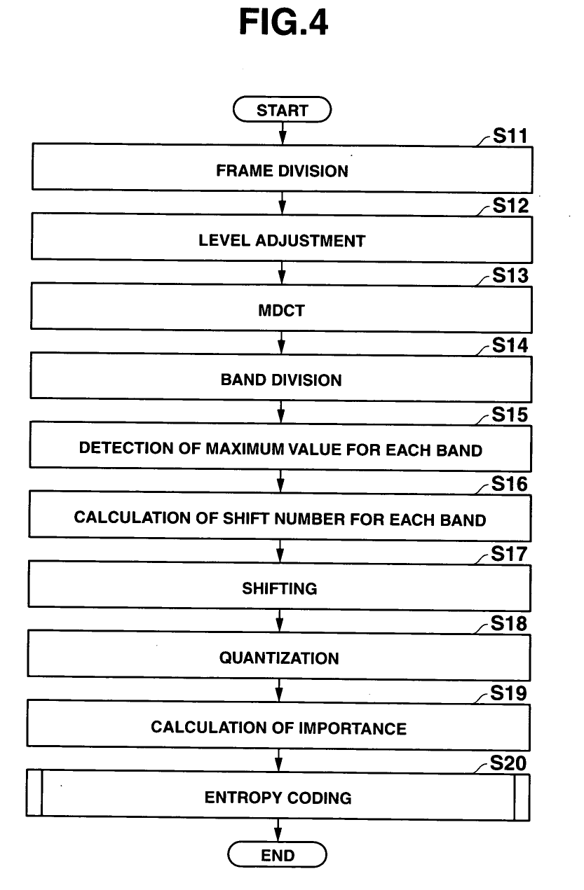

Subsequently, the audio coding processing executed by the audio coding apparatus 100 is described with reference to the flowchart of FIG. 4.

The frame dividing unit 11 divides an input audio signal into frames having constant length (step S11). The level adjustor 12 adjusts the level (amplitudes) of the input audio signal for each frame (step S12). The frequency converter 13 executes MDCT on the audio signal subjected to the level adjustment in order to calculate MDCT coefficients (frequency conversion coefficients) (step S13).

Thereafter, the band dividing unit 14 divides the frequency domain of the MDCT coefficients into bands according to the characteristic of human hearing (step S14). The maximum value detecting unit 15 detects the maximum absolute values of the MDCT coefficients in the every divided band (step S15). The shift number calculator 16 calculates the second shift bit number in every divided band in such a manner that the maximum value is controlled not to exceed the quantization bit rate preset in the band (step S16).

Subsequently, the shifting unit 17 shifts the entire data of the MDCT coefficients based on the second shift bit number calculated in the step S16 (step S17). The quantizer 18 performs the predetermined quantization (for example, scalar quantization) on the shifted signal (step S18).

Then, the importance calculator 19 calculates the importance levels of the respective frequency components from the MDCT coefficients acquired in the step S13 (step S19). The entropy coder 20 performs the entropy coding on the MDCT coefficients in order of the importance levels of the frequency components (step S20). Thereby, the audio coding processing is terminated.

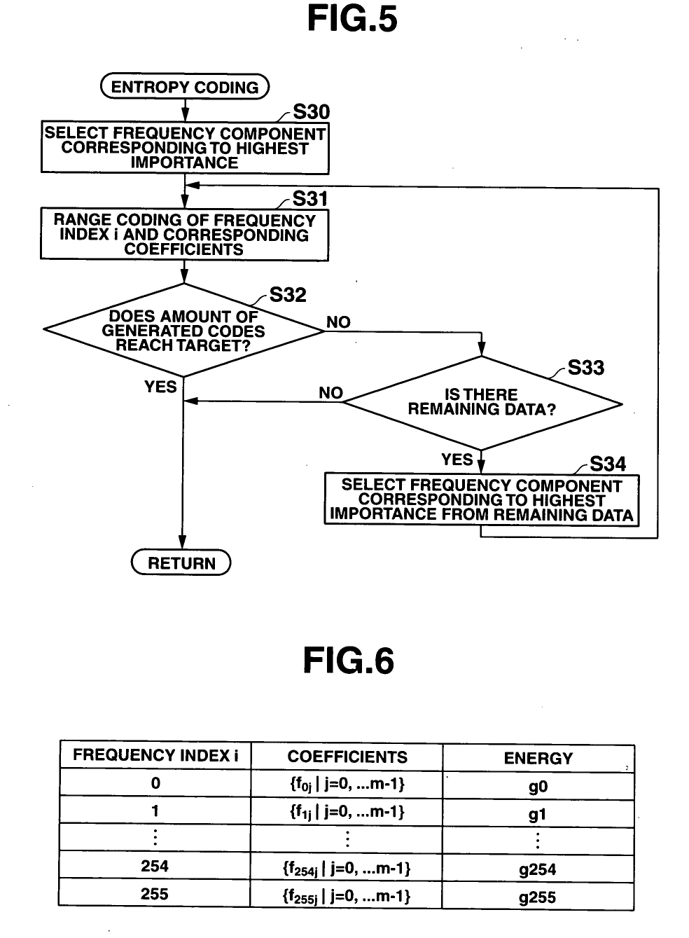

Thereafter, the entropy coding (step S20 in FIG. 4) performed by the entropy coder 20 is explained in detail with reference to the flowchart of FIG. 5.

The frequency index i of the frequency component corresponding to the highest importance level is selected from among the importance levels calculated by the importance calculator 19 in step S19 (step S30). The selected frequency index i and m coefficients of MDCT specified by the frequency index i are range coded (step S31).

It is determined whether or not the amount of the codes generated by the range coding in step S31 reaches the target code amount (step S32). When it is determined in step S32 that the amount of the codes reaches the target code amount (“YES” in step S32), the entropy coding is terminated.

When it is determined in step S32 that the amount of the generated codes does not reach the target code amount (“NO” in step S32), it is also determined whether or not there remains an MDCT coefficient (remaining data) which is not coded (step S33).

When it is determined in step S33 that the remaining data is present (“YES” in step S33), the frequency component of the highest importance level among the remaining data is selected (step S34). The processing in steps S31 and S32 is repeatedly performed for the selected frequency component. When it is determined in step S33 that there remains no data which is not coded (“NO” in step S33), the entropy coding is terminated.

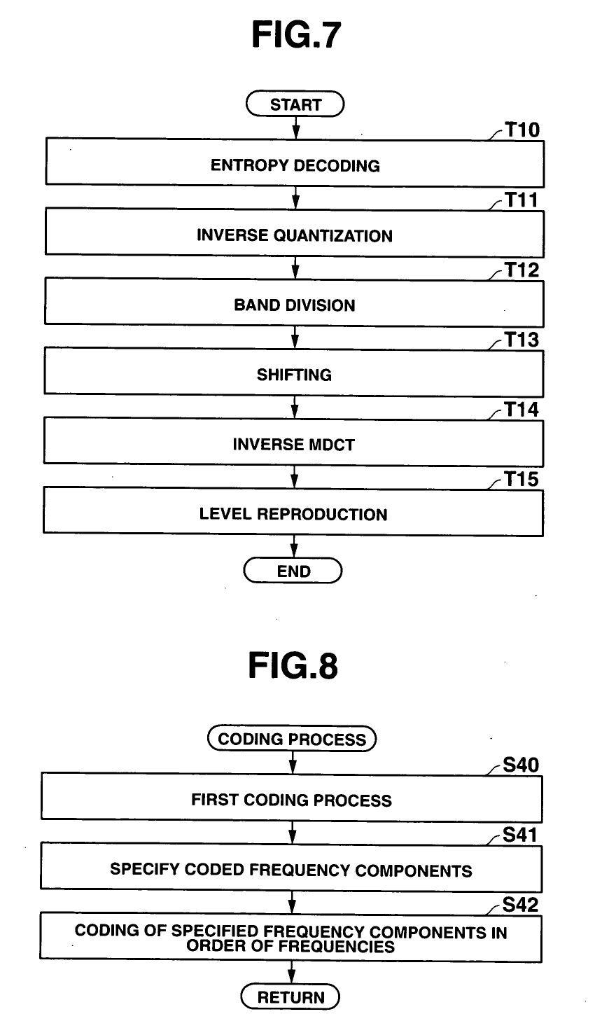

Thereafter, the audio decoding performed by the audio decoding apparatus 200 is described with reference to the flowchart of FIG. 7.

The entropy decoder 21 performs the entropy decoding on the signal which is entropy coded (step T10). The entropy decoding gives the following data, i.e., the first shift bit number for the level adjustment, the second shift bit numbers for the suppression of the maximum values in the respective divided bands, the frequency indexes, and the frequency conversion coefficients specified by the respective frequency indexes. The inverse quantizer 22 executes the inverse quantization on the frequency conversion coefficients data (step T11). When the number of MDCT coefficients contained in the processing target frame is less than the number of MDCT coefficients calculated at the time of coding by the frequency converter 13 in the audio coding apparatus 100, the deficient MDCT coefficients are substituted by the preset value (for example, zero).

Then, in the same way as in the coding, the band dividing unit 23 divides the frequency domain of the MDCT coefficients subjected to the inverse quantization into bands according to the characteristic of human hearing (step T12). The shifting unit 24 shifts the MDCT coefficients in the every divided band by the number of bits represented by the corresponding second shift bit number toward the most significant bit (MSB) side (step T13). The frequency inverse-converter 25 performs the inverse MDCT on the shifted data (step T14). Subsequently, the level reproducing unit 26 restores the level of the audio signal subjected to the inverse MDCT to the original level by the level adjustment (step T15). The frames which are the processing units of coding and decoding are combined by the frame synthesizing unit 27. Thereby, the audio decoding is terminated.

As described above, the audio coding apparatus 100 according to the present embodiment calculates the levels of importance in the respective frequency components, in advance of the execution of the entropy coding. The coding of the audio signal is performed in order of the calculated importance levels, until the amount of the generated codes reaches the target code amount. Therefore, it is not necessary to perform the coding many times in a similar manner to the conventional coding method. Moreover, it is possible to reduce the calculation amount.

Subsequently, modifications of the present embodiment are explained.

### First Modification

In the above-described embodiment, the entropy coding is performed in order of the importance levels of the frequency components. Therefore, the frequency index data indicating the order of coding is required to be involved in the coded data. Further, the coded data involving the frequency index data is transmitted to the audio decoding apparatus. In the first modification, similarly to the above-described embodiment, the entropy coding is performed in order of the importance levels. A second entropy coding of the frequency conversion coefficients subjected to the entropy coding is performed in numerical order of the frequencies. Accordingly, it is not necessary to transmit data indicating the order of coding. The coding processing carried out by the entropy coder 20 in the first modification is described in detail with reference to the flowchart of FIG. 8.

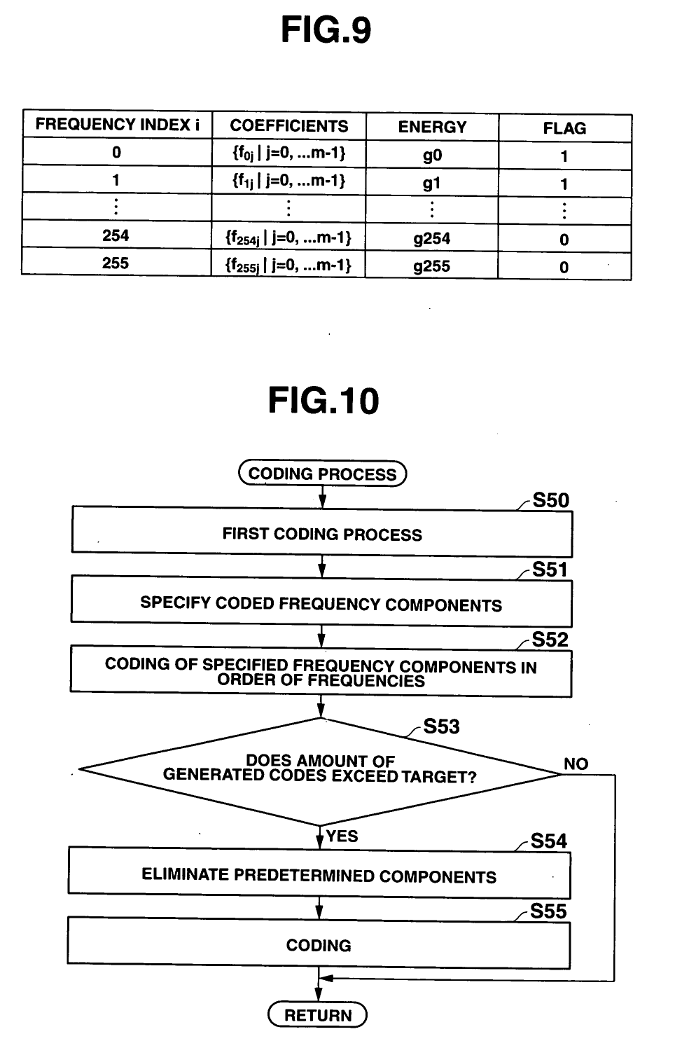

The entropy coding processing shown in FIG. 5 is performed as a first coding (step S40). Then, the frequency components serving as the coding targets in step S40 (selected frequency) are specified (step S41). Namely, a flag is affixed to the every frequency component so as to denote whether or not the frequency component is the coding target in step S40. FIG. 9 shows the relation among the frequency conversion coefficients {fᵢⱼ|j=0, . . . , m−1}, the energy gᵢ (refer to the equation (4)), and the flag for each frequency component. A value of the flag corresponding to a selected frequency which is specified in step S41 is substituted by 1. A value of the flag corresponding to the frequency component which is not specified as the selected frequency component is substituted by 0.

The entropy coding is executed in numerical order (e.g., in increasing order) of the frequency indexes on the frequency conversion coefficients corresponding to the frequency components specified in step S41 (the frequency components corresponding to the flags having value of 1). Furthermore, the data indicating which frequency component is coded (for example, a sequence of the flags shown in FIG. 9) is also coded and added to the coded data of the frequency conversion coefficients (step S42). Thereby, the coding processing of the first modification is terminated.

### Second Modification

In the first modification, the range coding is employed. In the range coding, a table of occurrence probability is sequentially updated according to an input of the audio signal. The occurrence probability table stores appearance probability of signs indicating the audio signal. Moreover, in the first modification, the first coding is performed based on the target code amount. Thereafter, the order of coding is changed in accordance with the numerical order of the frequencies and the second coding is performed. However, the amount of the generated codes may be larger than a target code amount due to the update of the occurrence probability table. In the second modification, when the amount of the codes generated by the coding processing of the first modification exceeds the target code amount, codes corresponding to the prescribed frequency components are eliminated. Therefore, the amount of generated codes is suppressed to be equal or less than the target code amount. The coding processing executed by the entropy coder 20 in the second modification is described in detail with reference to the flowchart of FIG. 10.

In the same way as in the first modification, the entropy coding shown in FIG. 5 is performed as the first coding (step S50). The coding target frequency components (selected frequency components) are specified according to the target code amount (step S51). The frequency conversion coefficients corresponding to the frequency components specified in step S51 are entropy coded in numerical order of the frequency indexes (step S52).

Sequentially, it is determined whether or not the amount of the generated codes exceeds the target code amount (step S53). When it is determined in step S53 that the amount of the generated codes does not exceed the target code amount (“NO” in step S53), the coding processing of the second modification is terminated.

When it is determined in step S53 that the amount of the generated codes exceeds the target code amount (“YES” in step S53), the data relating to the predetermined frequency component (for example, the frequency component of the highest frequency) is eliminated (step S54). Then, data remaining after the elimination in step S54 is subjected to the entropy-coding process (step S55) and the coding of the second modification is terminated.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. An audio coding apparatus comprising:
a frequency converter which performs frequency conversion on an audio signal to obtain frequency conversion coefficients;
an importance calculator which calculates importance levels of frequency components corresponding to the frequency conversion coefficients obtained by the frequency converter;
a coder which performs entropy coding of the frequency conversion coefficients to generate codes of the frequency conversion coefficients; and
a first comparing unit which compares an amount of the codes generated by the coder with a preset target code amount, wherein
the coder performs the entropy coding in order of the importance levels until the first comparing unit determines that the amount of the codes generated by the coder reaches the target code amount.

2. The audio coding apparatus according to claim 1, wherein the coder performs entropy coding in order of frequencies on the frequency conversion coefficients which are coded by the entropy coding in order of the importance levels.

3. The audio coding apparatus according to claim 2, further comprising
a second comparing unit which compares an amount of the codes generated by the entropy coding performed in order of the frequencies with the target code amount,
when the second comparing unit determines that the amount of the codes generated by the entropy coding performed in order of the frequencies exceeds the target code amount, the coder eliminates a frequency conversion coefficient corresponding to a predetermined frequency component from the generated codes and the coder performs entropy coding on remaining frequency conversion coefficients.

4. The audio coding apparatus according to claim 1, wherein the entropy coding includes a range coding.

5. The audio coding apparatus according to claim 1, further comprising:
a frame dividing unit which divides an input audio signal into frames having constant length;
an amplitude adjuster which adjusts amplitude of the audio signal based on a maximum amplitude contained in a frame of the audio signal and outputs the adjusted audio signal to the frequency converter;
a band dividing unit which divides a frequency domain of the frequency conversion coefficients obtained by the frequency converter into bands based on a characteristic of human hearing;
a detection unit which detects a maximum absolute value of the frequency conversion coefficients in a band divided by the band dividing unit,
a shift-number calculator which calculates a number of bits to be shifted in such a manner that the maximum absolute value detected by the detection unit is controlled not to become larger than a predetermined quantization bit rate; and
a shifting unit which shifts the frequency conversion coefficients in the band by the number of bits calculated by the shift-number calculator, wherein
the coder performs entropy coding on the frequency conversion coefficients shifted by the shifting unit.

6. The audio coding apparatus according to claim 1, wherein the frequency conversion includes a modified discrete cosine transform.

7. An audio coding method comprising:
performing frequency conversion on an audio signal to obtain frequency conversion coefficients;
calculating importance levels of frequency components corresponding to the frequency conversion coefficients obtained by the frequency conversion;
performing entropy coding of the frequency conversion coefficients to generate codes of the frequency conversion coefficients; and
comparing an amount of the codes generated by the entropy coding with a preset target code amount, wherein
the entropy coding is performed in order of the importance levels until it is determined that the amount of the codes generated by the entropy coding reaches the target code amount.

8. The audio coding method according to claim 7, wherein the entropy coding is performed in order of frequencies on the frequency conversion coefficients which are coded by the entropy coding in order of the importance levels.

9. The audio coding method according to claim 8, further comprising
comparing an amount of the codes generated by the entropy coding performed in order of the frequencies with the target code amount,
when it is determined that the amount of the codes generated by the entropy coding performed in order of the frequencies exceeds the target code amount, a frequency conversion coefficient corresponding to a predetermined frequency component is eliminated from the generated codes and the entropy coding is performed on remaining frequency conversion coefficients.

10. The audio coding method according to claim 7, wherein the entropy coding includes a range coding.

11. The audio coding method according to claim 7, further comprising:
dividing an input audio signal into frames having constant length;
adjusting amplitude of the audio signal based on a maximum amplitude contained in a frame of the audio signal and outputting the adjusted audio signal to the frequency converter;
dividing a frequency domain of the frequency conversion coefficients into bands based on a characteristic of human hearing;
detecting a maximum absolute value of the frequency conversion coefficients in the divided band,
calculating a number of bits to be shifted in such a manner that the detected maximum absolute value is controlled not to become larger than a predetermined quantization bit rate; and
shifting the frequency conversion coefficients in the band by the number of bits to be shifted, wherein
the entropy coding is performed on the shifted frequency conversion coefficients.

12. The audio coding apparatus according to claim 7, wherein the frequency conversion includes a modified discrete cosine transform.

13. An audio decoding apparatus comprising:
a decoder which decodes frequency conversion coefficients of an audio signal coded by entropy coding, wherein the entropy coding is performed in order of frequencies on frequency conversion coefficients generated by frequency conversion on the audio signal until an amount of generated codes reaches a preset target code amount; and
an frequency inverse-converter which performs inverse frequency conversion on the frequency conversion coefficients decoded by the decoder.

14. The audio decoding apparatus according to claim 13, wherein the decoder substitutes a predetermined value for a deficient frequency conversion coefficient when a number of the frequency conversion coefficients decoded by the decoder is less than a number of the frequency conversion coefficients generated by the frequency conversion.

15. An audio decoding method comprising:
decoding frequency conversion coefficients of an audio signal coded by entropy coding, wherein the entropy coding is performed in order of frequencies on frequency conversion coefficients generated by frequency conversion on the audio signal until an amount of generated codes reaches a preset target code amount; and
performing inverse frequency conversion on the decoded frequency conversion coefficients.

16. The audio decoding method according to claim 15, wherein a predetermined value is substituted for a deficient frequency conversion coefficient when a number of the decoded frequency conversion coefficients is less than a number of the frequency conversion coefficients generated by the frequency conversion.
